(19) United States
(12) Patent Application Publication
(10) Pub. No.: US 2008/0244244 A1
(43) Pub. Date: Oct. 2, 2008

(54) PARALLEL INSTRUCTION PROCESSING AND OPERAND INTEGRITY VERIFICATION

(75) Inventors: Michael E. Tuuk, Austin, TX (US); David E. Kroesche, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: ADVANCED MICRO DEVICES, INC., Sunnyvale, CA (US)

(21) Appl. No.: 11/694,870

(22) Filed: Mar. 30, 2007

(51) Int. Cl. G06F 9/30

(52) U.S. Cl. 712/226

(57) ABSTRACT

A method includes accessing, at a processing device, operand data associated with an instruction operation from a data cache and executing, at the processing device, the instruction operation using the operand data prior to determining the validity of the operand data. The method further includes retiring, at the processing device, the instruction operation in response to determining the operand data is valid. A processing device includes a data cache and an instruction pipeline. The instruction pipeline includes an execution stage configured to execute an instruction operation using operand data access from the data cache prior to determining the validity of the operand data and a retire stage configured to retire the instruction operation in response to determining the operand data is valid.

### FIELD OF THE DISCLOSURE

The present disclosure relates generally to instruction processing in a pipelined processing device and more particularly to error detection/correction of operand data in a pipelined processing device.

### BACKGROUND

The execution of instructions often relies on operand data stored in storage elements that are susceptible to data corruption due to a variety of factors, including static discharge, parasitic capacitance, structural imperfections, and the like. Accordingly, many processing devices utilize error correcting code (ECC) or similar error detection/correction techniques to verify the integrity of operand data loaded from storage for use while processing instructions. In conventional pipelined processors, operand data for an instruction is fetched from a cache or other storage device and its integrity is verified before processing of the instruction using the fetched data can resume. As the error detection/correction process used to verify the integrity of fetched data may require more than one cycle to complete, the instruction pipeline typically is delayed by a number of cycles until the error detection/correction process is completed. This delay increases the overall number of cycles to process the instruction and therefore significantly degrades the processing efficiency of the processing device. Accordingly, an improved technique for verifying the integrity of operand data in a pipelined processing device would be advantageous.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating an example pipelined processing device utilizing parallel error detection/correction in accordance with at least one embodiment of the present disclosure.

FIG. 2 is a flow diagram illustrating an example method for parallel instruction processing and error detection/correction in accordance with at least one embodiment of the present disclosure.

FIGS. 3-6 are diagrams illustrating an example of parallel instruction processing and error detection/correction in the example pipelined processing device of FIG. 1 in accordance with at least one embodiment of the present disclosure.

The use of the same reference symbols in different drawings indicates similar or identical items.

### DETAILED DESCRIPTION

In accordance with one aspect of the present disclosure, a method includes accessing, at a processing device, operand data associated with an instruction operation from a data cache and executing, at the processing device, the instruction operation using the operand data prior to determining the validity of the operand data. The method further includes retiring, at the processing device, the instruction operation in response to determining the operand data is valid.

In accordance with another aspect of the present disclosure, a method includes receiving, at a first time, a first instruction operation at a processing device and accessing, at a second time subsequent to the first time, operand data associated with the first instruction operation from a data cache. The method further includes providing, at a third time subsequent to the second time, the first instruction operation and the operand data for execution at the processing device and determining, at a fourth time subsequent to the third time, the operand data is valid. The method additionally includes receiving, at a fifth time subsequent to the third time, execution results for the first instruction operation and retiring, at a sixth time subsequent to the fourth time and the fifth time, the first instruction operation at the processing device.

In accordance with yet another aspect of the present disclosure, a processing device includes a data cache and an instruction pipeline. The instruction pipeline includes an execution stage configured to execute an instruction operation using operand data access from the data cache prior to determining the validity of the operand data and a retire stage configured to retire the instruction operation in response to determining the operand data is valid.

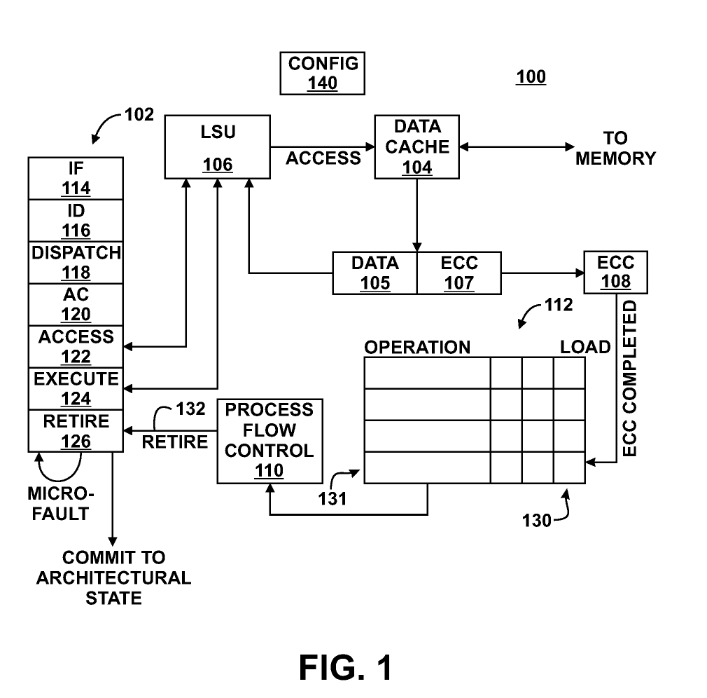

FIGS. 1-6 illustrate techniques for processing instruction operations in a pipelined processing system without introducing substantial delay due to the data integrity verification of instruction operands or other instruction information fetched from a data cache or other storage element. In at least one embodiment, operand data and its corresponding error correcting code (ECC) data is fetched from the data cache. The fetched operand data is presumed valid and further processing of the instruction operation is enabled even though the integrity of the operand data has not yet been verified using the ECC data. The processing of the instruction operation and its fetched operand data can continue through the various stages of the instruction pipeline while an error detection/correction process is performed on the fetched operand data using the fetched ECC data so as to verify the integrity of the fetched operand data. The processing of the instruction operation continues through the instruction pipeline until the instruction is otherwise ready to retire and any results of the processing of the instruction are otherwise ready to be committed to the architectural state of the processing device. The instruction pipeline delays retiring the instruction and committing the results of the instruction to the architectural state until the error detection/correction process has concluded and the fetched operand data has been identified as valid, or not corrupt. In response to identifying the fetched operand data as valid, the processing device commits the instruction results to architectural state and retires the instruction. In the event that the fetched operand data is identified as invalid, or corrupt, during the parallel error detection/correction process, the instruction pipeline generates an exception to handle the error.

As used herein, the term “error detection/correction process” and its variants refer to an error detection process or an error detection and correction process. For ease of illustration, various embodiments are described in the context of error correcting code (ECC)-based techniques. However, other error detection/correction processes can be utilized without departing from the scope of the present disclosure.

FIG. 1 illustrates an example processing device 100 in accordance with at least one embodiment of the present disclosure. The processing device 100 can include, for example, a microprocessor, a microcontroller, an application specific integrated circuit (ASIC), and the like. In the depicted example, the processing device 100 includes an instruction pipeline 102, a data cache 104, a load/store unit (LSU) 106, an ECC unit 108, a process flow control unit 110, and a reorder buffer 112.

The instruction pipeline 102, in one embodiment, comprises a plurality of processing stages configured to process instruction operations represented by instruction data fetched from an instruction cache or other storage element (not shown). In the depicted example, the processing stages include an instruction fetch (IF) stage 114, an instruction decode (ID) stage 116, a dispatch stage 118, an address calculation (AC) stage 120, an operand access stage 122, an execute stage 124, and a retire stage 126. Each of the stages 114, 116, 118, 120, 122, 124, and 126 (collectively, “stages 114-126”) can include one or more sub-stages. The IF stage 114 is configured to fetch instruction data. The ID stage 116 is configured to decode fetched instruction data to generate corresponding instruction operations. The dispatch stage 118 is configured to dispatch instruction operations to the remaining stages of the instruction pipeline 102. The AC stage 120 is configured to calculate addresses associated with the decoded instruction operations, such as an effective address or a virtual address associated with an operand of a decoded instruction operation. The operand access stage 122 is configured to initiate the process of loading (fetching) operand data from the data cache 104 or from memory (not shown) based on the addresses determined at the AC stage 120. The execute stage 124, in one embodiment, comprises one or more functional units, such as integer units and floating point units, to execute operations represented by instruction operations using fetched operand data. The retire stage 126 is configured to buffer the results of the operations executed by the functional units of the execute stage 124 until they are ready to be committed to the architectural state of the processing device 100, such as by writing the results to an architectural state register file (not shown).

In at least one embodiment, the instruction pipeline 102 is enabled to perform out-of-order instruction processing. Accordingly, in one embodiment, the processing device 100 utilizes the reorder buffer 112 so that the instruction and its results can be reordered consistent with the original program order. The reorder buffer 112 includes a plurality of entries, each entry corresponding to an instruction or operations being processed by the instruction pipeline 102. The reorder buffer 112 is configured as a circular first-in first-out (FIFO) buffer such that the order of the entries and the instructions represented therein represents the original program order and whereby the last entry (last entry 131 of FIG. 1) represents the least recent instruction (i.e., oldest in program order) of the instructions being processed at that time. Each entry includes a plurality of fields to store relevant information about the corresponding instruction, including, for example, an instruction identifier (e.g., at least a portion of the instruction address), operand data, instruction results data, rename register identifiers, and the like. Further, each entry includes one or more status fields indicating various statuses of the instruction, such as its current stage of processing, whether certain actions have been completed, and the like. In the depicted example, each entry of the reorder buffer 112 includes a load status field 130 used to indicate whether a load of operand data for the corresponding instruction has been completed (whereby the completion of load indicates that the loaded data also is valid). In one embodiment the load status field 130 comprises a one-bit field, where an uncompleted state is indicated using, for example, a “0” and a completed state is indicated using, for example, a “1”. Upon associating an instruction being processed with a given entry of the reorder buffer 112, the load status field 130 of the entry is initialized to indicate that the load operation has not been completed by, for example, writing a “0” to the load status field 130.

The LSU 106, in one embodiment, manages load and store operations to the data cache 104, as well as memory accesses to memory (not shown) in response to cache misses. The data cache 104 includes a cache to store data associated with fetched instructions, including operand data, instruction result data, and the like. Further, in one embodiment, the data cache 104 includes ECC data for each cache entry (e.g., cache line) or other cache granularity. The data cache 104 can include a set associative cache, a fully associative cache, and the like.

The ECC unit 108, in one embodiment, is configured to perform an error detection/correction process for fetched operand data 105 using the corresponding ECC data 107 to identify whether the fetched operand data 105 has any errors, and if possible, to correct any detected errors, whereby the fetched operand data 105 and ECC data 107 are fetched by the LSU 106 from the data cache 104, or alternately from memory in the event of a cache miss. In some instances the ECC unit 108 may be configured such that single bit errors can be corrected, whereas multiple bit errors can only be detected but not corrected due to the limitations of the ECC data 107 and the error detection/correction process. In other instances, the ECC unit 108 may be capable of correcting multiple bit errors. When the ECC unit 108 has completed the ECC process for a fetched operand data 105 and when the fetched operand data 105 has been verified as valid, the ECC unit 108, in one embodiment, modifies the load status field 130 of the entry of the reorder buffer 112 corresponding to the instruction that initiated the load of the operand data 105 so as to reflect the completed and verified status of the error detection/correction process for the fetched operand data 105. In the example described above, the ECC unit 108 can identify the load as completed by writing a “1” to the load status field 130 of the corresponding entry of the reorder buffer 112.

In the event that the ECC unit 108 has identified an error in the fetched operand data 105, the ECC unit 108 provides an error indicator that identifies the fetched operand data 105 as invalid. In response to this error indicator, the process flow control unit 110 generates a microfault or other exception so as to initiate an error correction process, whereby microcode is executed by the instruction pipeline 102 to handle and correct the error in the cache identified from the fetched operand data 105.

The process flow control unit 110 is configured to manage the operation of the instruction pipeline 102 and to monitor the states of the various processing stages and the instructions being processed therein. In at least one embodiment, the process flow control unit 110 is configured to monitor the last entry 131 of the reorder buffer 112 (associated with the first instruction to occur in the original program order of the instructions currently being processed by the instruction pipeline 102). In response to determining from the last entry 131 that the corresponding instruction is ready to retire, the process flow control unit 110 is configured to issue a retire indicator 132 to the retire stage 126, in response to which the retire stage 126 retires the instruction and commits any results of the processing of the corresponding instruction to the architectural state of the processing device 100. Upon retiring the instruction represented by the last entry 131 and committing the instruction results, the process flow control unit 110 increments the last entry pointer of the reorder buffer 112 to the next entry, thereby effectively removing the retired instruction from the reorder buffer 112.

As part of the process to determine whether instruction results are ready to retire, the process flow control unit 110 monitors the status fields of the last entry 131, including the load status field 130. While any of the status fields indicate that the corresponding action has not yet been completed, the process flow control unit 110 refrains from issuing the retire indicator 132, thereby maintaining the instruction at the retire stage 126. When the process flow control unit 110 determines from the status fields that all pending actions for the instruction have been completed (including the error correction/detection process represented by the load status field 130), the process flow control unit 110 issues the retire indicator 132.

In at least one embodiment, the fetched operand data 105 is presumed valid and the processing of the instruction data and the fetched operand data 105 continues to the execute stage 124 and subsequent stages without waiting for verification of the integrity of the fetched operand data 105 from the ECC unit 108. Further, the instruction pipeline 102 can facilitate the operation of subsequent instruction operations having dependencies on earlier instruction operations, such as by performing operand forwarding without verifying the integrity of the fetched operand data. The ECC unit 108 performs an error detection/correction process to determine the integrity of the fetched operand data 105 using the corresponding ECC data 107 in parallel with the processing of the instruction operation and the fetched operand data 105 at the subsequent stages of the instruction pipeline 102. Upon validating the integrity of the fetched operand data 105, the ECC unit 108 modifies the load status field 130 of the corresponding entry from an initialized first state (e.g., a “0”) to a second state (e.g., a “1”), thereby indicating that the load action (including data integrity verification) has been completed. Thus, because the process flow control unit 110 refrains from issuing the retire indicator 132 until the load status field 130 of the last entry 131 is set to the second state (thereby indicating the load action is complete), the retirement of the instruction results using the fetched operation data is delayed until the fetched operand data 105 has been verified as valid. In the event that the error detection/correction process performed by the ECC unit 108 identifies the fetched operand data 105 as invalid, the process flow control unit 110 (or other component) instead issues an exception to initiate an error handling routine.

The parallelization of the subsequent processing of an instruction operation and its fetched operand data and the process of verifying the integrity of the fetched operand data typically results in increased instruction-per-cycle throughput. To illustrate, in conventional pipelined processors, the pipeline would stall at the operand access stage until the fetched operand data was verified as valid, at which point the processing of the instruction operation and the verified operand data would then be permitted resume. Because the error detection/correction process can take a number of cycles, the delay to wait for verification before proceeding typically lengthened the overall pipeline processing duration by several cycles. In contrast, for the parallel scheme described above, little or no delay is introduced by configuring the retirement of instruction results to wait on verification of the integrity of the fetched operand data because the instruction typically is several cycles away from being retired due to other instructions ahead of it in the reorder buffer 112, which in most cases will allow the ECC unit 108 ample time to determine the validity of the fetched operand data and configure the load status field 130 of the corresponding entry of the reorder buffer 112 accordingly. Further, operations within the instruction pipeline 102 often are dependent on one or more prior operations. Thus, by accelerating the processing of an instruction operation without waiting for the integrity of its fetched operation to be verified, the processing of dependent instruction operations can proceed without delay, thereby further increasing overall processing efficiency of the processing device 100. The continued processing of instruction operations using unverified operand data can incur a greater processing penalty in the event that the operand data is ultimately resolved to be invalid compared to conventional techniques whereby the processing is stalled until the operand data is verified due to the need to flush and restart the latter stages of the pipeline. However, the occurrence of invalid operand data is rare in most implementations and thus the net efficiency of the typical instruction processing outbalances the potential penalty incurred by the rare exceptions.

Tables 1 and 2 illustrate a potential for increased efficiency due to the parallel instruction processing and error correction/detection process. Table 1 illustrates a conventional instruction pipeline whereby verification of fetched operand data is required before the instruction operation can proceed to the next processing stage. Table 2 illustrates an instruction pipeline having parallel instruction processing and error detection/correction as described herein.

TABLE 1
Conventional Instruction Pipeline For Operations A and B

| Cycle | Load | Dependent Operation |
|---|---|---|
| 1 | Dispatch Op. A | — |
| 2 | Address Calculation | — |
| 3 | Operand Access | — |
| 4 | ECC check 1 | Dispatch |
| 5 | ECC check 2 | Operand Access (other registers, etc.) |
| 6 | Return Data | Execute |
| 7 | — | Result (Execute Op. B) |

TABLE 2
Parallel Instruction Processing/Error Detection Operations A and B

| Cycle | Load | Dependent Operation |
|---|---|---|
| 1 | Dispatch Op. A | — |
| 2 | Address Calculation | Dispatch Op. B |
| 3 | Operand Access | Operand Access (other registers, etc.) |
| 4 | Return Data | Execute |
| 5 | — | Result (Execute Op. B) |

In the example of Table 1, it takes six cycles between when an instruction operation A is dispatched before the next dependent instruction operation B can be executed due to the two cycle delay while waiting for fetched operand verification. In contrast, the example of Table 2 illustrates that only four cycles occur between the dispatch of an instruction operation A and the execution of the next dependent instruction operation B, providing a savings of two cycles, which can accumulate for multiple dependencies.

In one embodiment, the processing system 100 further includes a configuration component 140 or other configuration mechanism whereby a user, manufacturer or supplier can configure the processing device 100 to operate in either the parallel ECC/processing mode described above or in a conventional mode whereby instruction processing is stalled until the integrity of fetched operand data is verified. The configuration component 140 further can be used to configure the processing system 100 to a mode whereby the processing of instruction operations is performed and completed without waiting for verification of the integrity of the fetched operand data in any manner. In this mode, the detection of an ECC error is treated as a fatal exception as the instruction results may have already committed to the architectural state. Thus, the configuration component 140 can be used to customize the processing device 100 to the particular environment in which it is expected to operate. To illustrate, in certain operating environments invalid operand data may be expected to be rare and a fatal error may be of little consequence. Accordingly, in this instance it may be appropriate to configure the processing device 100 via the configuration component 140 to operate in a mode whereby instruction processing is performed and completed without waiting for ECC verification. In other environments, such as automotive or aerospace settings, where speed and resiliency are highly desired, it may be more appropriate to configure the processing device 100 via the configuration component 140 to operate in the parallel ECC/processing mode described herein.

In one embodiment, the configuration component 140 includes a fuse or anti-fuse used to control the ECC detection mode. Thus, a manufacturer, supplier, or user can program the fuse/anti-fuse according to the desired mode. In another embodiment, the configuration component 140 includes a software-programmable register that can be configured in, for example, the basic input-output system (BIOS). Further, the configuration component 104 can include both the fuse and the software-programmable register, whereby the software-programmable register can be utilized to override the setting configured by the state of the fuse.

Although FIG. 1 illustrates an embodiment whereby the instruction pipeline 102 is an out-of-order pipeline and thus the reorder buffer 112 can be advantageously used to store an indicator (e.g., the load status field 130) that is manipulated to reflect the status of the error detection/correction process on the corresponding fetched operand data, other implementations of similar indicator can be utilized without departing from the scope of the present disclosure. To illustrate, in one embodiment, a dedicated register, register file, or other storage element can be used to maintain indicators for the status of the error detection/correction processes performed on fetched operand data. The process flow control unit 110 then can use these dedicated storage elements to determine whether to retire an instruction and commit its results based on the state of the corresponding indicator. Further, while FIG. 1 illustrates one embodiment whereby the load status field 130 of the reorder buffer 112 is utilized to also provide the status of the ECC verification process, it will be appreciated that a separate field, such as and ECC check field, can instead be used to indicate the status of the ECC verification process.

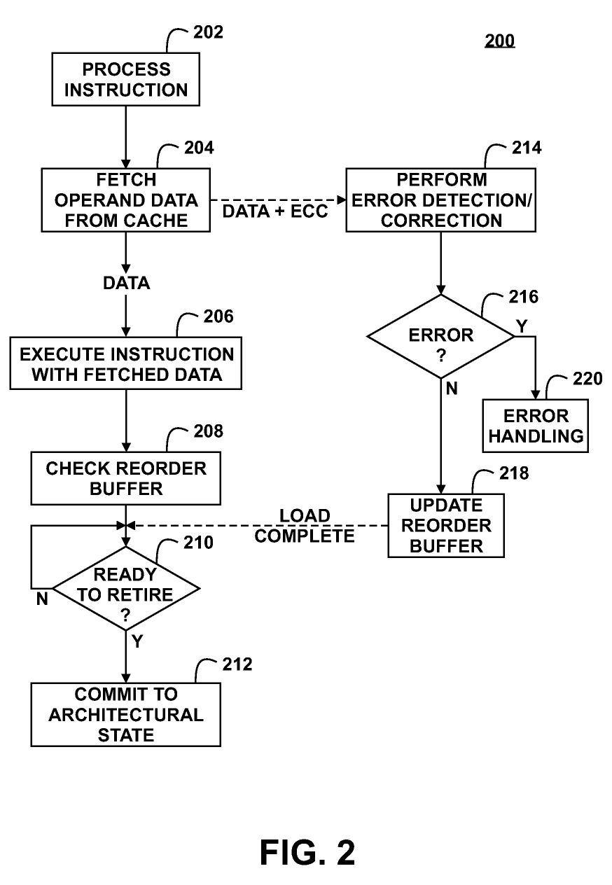

FIG. 2 illustrates an example method 200 of operation of the processing device 100 of FIG. 1 in accordance with at least one embodiment of the present disclosure. At block 202 an instruction is fetched and processed at the initial stages of the instruction pipeline 102. This processing includes instruction fetching, decoding, dispatch, address calculation, and the like. Further, an entry of the reorder buffer 112 is initialized for the instruction. At block 204, the operand data to be used for the execution of the instruction's operations and its corresponding ECC data are fetched from the data cache 104.

At block 206, the processing of the instruction continues with the fetched operand data without waiting to verify the integrity of the fetched operand data. This processing can include, for example, buffering the instruction and fetched operand data, executing instruction operations using the fetched operand data at one or more functional units of the execute stage 124, and preparing the instruction results for retirement at the retire stage 126. As the processing of the instruction progresses, the program flow control unit 110 updates the information of the corresponding entry of the reorder buffer 112 as appropriate.

At block 208, the process flow control unit 110 accesses the last entry 131 of the reorder buffer 112 (assuming the instruction fetched at block 202 is at this point the oldest instruction being processed) to determine whether all pending actions associated with the instruction have been completed. As part of this process, the load status field 130 of the last entry 131 is checked to determine whether the load action has completed. At block 210, the process flow control unit 110 determines whether the instruction is ready to be retired based on the access to the last entry 131 of the reorder buffer 112 performed at block 208. In the event that a status field of the last entry 131 indicates that a corresponding action has not been completed, the process flow control unit 112 maintains the instruction at the retire stage 126. When the process flow control unit 110 identifies that the status fields of the last entry 131 indicate that all pending actions have been completed, the process flow control unit 110 signals for the instruction to be retired at block 212. The retirement of the instruction can include, for example, committing the instruction results to the architectural state of the processing device 100.

In parallel with the processing of an instruction using its corresponding fetched operation data, the fetched operand data and its corresponding ECC data are provided to the ECC unit 108, whereupon the ECC unit 108 performs an error detection/correction process using the fetched operand data 105 and the ECC data 107. At decision block 216, the ECC unit 108 determines whether the fetched operand data is valid based on the results of the error detection/correction process. If an error is not detected in the fetched operand data, at block 218 the ECC unit 108 updates the reorder buffer 112 by changing the load status field 130 of the corresponding entry to reflect that the load action has been completed (e.g., by writing a “1” to the load status field 130). Otherwise, if an error is detected in the fetched operand data, an exception is generated and an error handling mechanism is invoked at block 220 to recover from the execution of the instruction (and possibly the execution of instruction operations with dependencies) using invalid operand data. In at least one embodiment, the exception is handled by flushing the instruction pipeline 102 of previous instructions and invoking a microfault, which utilizes a combination of microcode and hardware to correct the data cache 104 with respect to the error in the fetched operand data and to restart the load operation.

As FIG. 2 illustrates, the commitment of instruction results is dependent upon the update of the reorder buffer 112 by the ECC unit 108 upon its verification of the integrity of fetched operand data. The configuration of the processing device 100 to continue with processing of an instruction without waiting for verification of the fetched operand data reduces the number of cycles needed to process the instruction between when it is fetched and when its results are available to be committed. Further, delaying any available instruction results from being committed until the integrity of the operand data used to generate the instruction results has been verified prevents the typically unrecoverable situation whereby invalid instruction results have been committed to architectural state. However, due to the delay between the fetching of operand data and the generation of instruction results due to the various processing stages in between, the integrity state (e.g., valid or invalid) of the fetched operand data typically will have already been determined by the time the instruction results have been generated, or shortly thereafter, in most instances, thereby introducing little or no delay in the commitment of the instruction results.

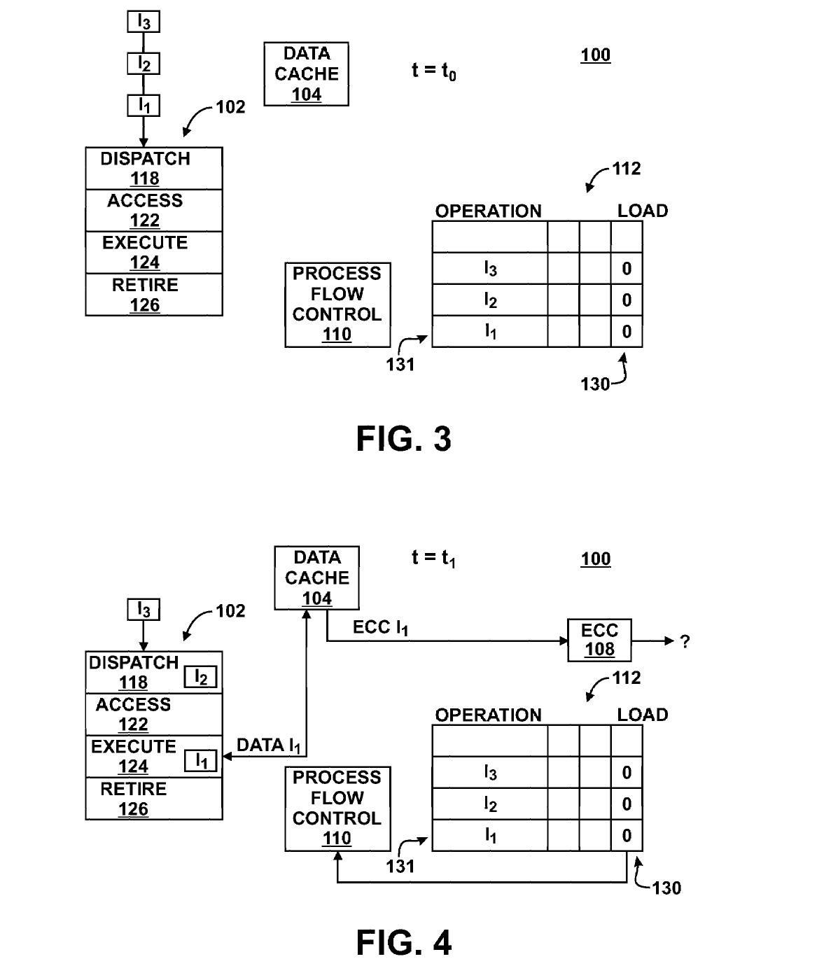

FIGS. 3-6 illustrate an example instruction execution scenario in the context of the parallel error detection/instruction processing technique of FIGS. 1 and 2 in accordance with at least one embodiment of the present disclosure. FIG. 3 illustrates an initial state of the processing device 100 at time t₀. In this example, a sequence of instructions I₁-I₃ has been fetched and decoded by the instruction pipeline 102, whereby instruction I₁ is first in program order, instruction I₂ is second in program order, and instruction I₃ is third in program order. Further, it is assumed for ease of discussion that the instruction pipeline 102 processes the instructions I₁-I₃ in program order. At time t₀, three entries of the reorder buffer 112 have been initiated for instructions I₁-I₃, whereby instruction I₁ is at the last entry 131 of the reorder buffer 131 due to it being the oldest instruction currently being processed at the instruction pipeline 102. Also, the load status field 130 of each of the three entries is initialized to a “0” to indicate an uncompleted load action.

FIG. 4 illustrates a state of the processing device 100 at time t₁ whereby the instruction I₁ has been processed at the dispatch stage 118 and the operand access stage 122 and is being processed at the execute stage 124. During processing of the instruction I₁ at the operand access stage 122, a load operation was initiated to fetch operand data for instruction I₁ (referred to herein as “data I₁”) from the data cache 104 or from memory. At time t₁ represented in FIG. 4, the data I₁ and corresponding ECC data (referred to herein as “ECC I₁”) have been fetched from the data cache 104 and the data I₁ has been utilized at the execute stage 124 for execution of the instruction I₁. However, at time t₁, the ECC unit 108 has not yet determined the integrity status of the data I₁, and thus the load status field 130 of the entry of the reorder buffer 112 for the instruction I₁ remains at “0”. Accordingly, the process flow control unit 110 refrains from signaling that the instruction I₁ can be retired.

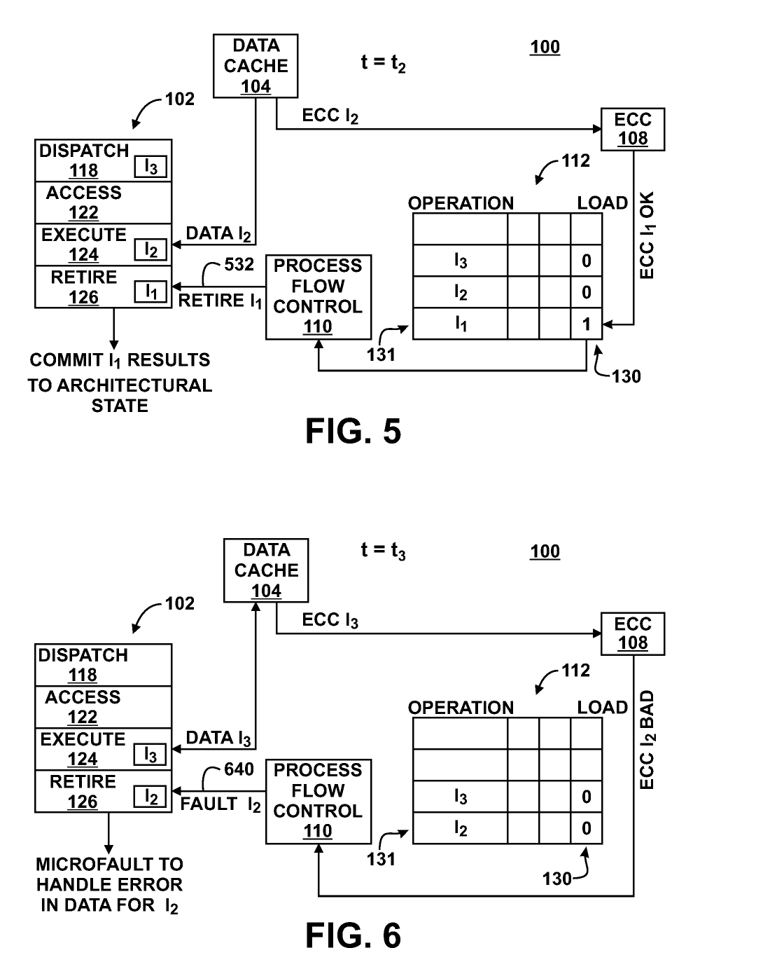

FIG. 5 illustrates a state of the processing device 100 at time t₂ whereby the processing of the instruction I₁ has completed and the instruction I₂ has processed at the dispatch stage 118 and the operand access stage 122 and is being processed at the execute stage 124. During processing of the instruction I₂ at the operand access stage 122, a load operation was initiated to fetch operand data for instruction I₂ (referred to herein as “data I₂”) from the data cache 104 or from memory. At time t₂ represented in FIG. 5, the data I₂ and corresponding ECC data (referred to herein as “ECC I₂”) have been fetched from the data cache 104 and the data I₂ has been utilized at the execute stage 124 for execution of the instruction I₂. However, at time t₂, the ECC unit 108 has not yet determined the integrity status of the data I₂, and thus the load status field 130 of the entry of the reorder buffer 112 for the instruction I₂ remains at “0”.

Further, by time t₂ the ECC unit 108 has determined that the data I₁ is valid and thus has changed the load status field 130 of the entry of the reorder buffer 112 corresponding to instruction I₁ to a “1.” As instruction I₁ occupies the last entry 131 of the reorder buffer 112, the changing of the load status field 130 to a “1” triggers the process flow control unit 110 to issue a retire indicator 532 to the retire stage 126 (assuming all other actions have been completed for instruction I₁). In response to the retire indicator 532, the retire stage 126 commits the results of instruction I₁ to the architectural state of the processing device 100 and retires instruction I₁. Further, the last entry pointer of the reorder buffer 112 is adjusted so that the entry corresponding to the instruction I₂ becomes the last entry 131.

FIG. 6 illustrates a state of the processing device 100 at time t₃ whereby the processing of the instruction I₂ has been completed and the instruction I₃ has processed at the dispatch stage 118 and the operand access stage 122 and is being processed at the execute stage 124. During processing of the instruction I₃ at the operand access stage 122, a load operation was initiated to fetch operand data for instruction I₃ (referred to herein as “data I₃”). At time t₃ represented in FIG. 6, the data I₃ and corresponding ECC data (referred to herein as “ECC I₃”) have been fetched from the data cache 104 and the data I₃ has been utilized at the execute stage 124 for execution of the instruction I₃. However, at time t₃, the ECC unit 108 has not yet determined the integrity status of the data I₃, and thus the load status field 130 of the entry of the reorder buffer 112 for the instruction I₃ remains at “0”.

Further, by time t₃ the ECC unit 108 has determined that the data I₂ has an error and therefore is invalid. In response, the process flow control unit 110 issues a fault indicator 640 to the retire stage 126, thereby indicating an exception and invoking an exception handling mechanism. In response to the fault indicator 640, the retire stage 126 and the process flow control unit 110 (FIG. 1) flush all subsequent instructions from the instruction pipeline 102 and initiates microcode that corrects the error and restarts the processing of the instruction I₂ and the instructions that utilize the data I₂.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert” or “set” and “negate” (or “deassert” or “clear”) are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Other embodiments, uses, and advantages of the disclosure will be apparent to those skilled in the art from consideration of the specification and practice of the disclosure disclosed herein. The specification and drawings should be considered exemplary only, and the scope of the disclosure is accordingly intended to be limited only by the following claims and equivalents thereof.

What is claimed is:

1. A method comprising:
accessing, at a processing device, operand data associated with an instruction operation from a data cache;
executing, at the processing device, the instruction operation using the operand data prior to determining the validity of the operand data; and
retiring, at the processing device, the instruction operation in response to determining the operand data is valid.

2. The method of claim 1, further comprising:
performing, at the processing device, an error detection process to determine the validity of the operand data in parallel with executing the instruction operation.

3. The method of claim 2, wherein performing an error detection process comprises:
accessing error correcting code (ECC) data associated with the operand data from the data cache; and
performing an error detection process using the operand data and the ECC data to determine the validity of the operand data.

4. The method of claim 1, further comprising:
setting a field of an entry of a reorder buffer associated with the instruction operation to a predetermined state in response to determining the operand data is valid; and
wherein retiring the instruction operation comprises retiring the instruction operation in response to determining the field of the entry of the reorder buffer has been set to the predetermined state.

5. The method of claim 1, wherein:
retiring the instruction operation comprises committing results of the execution of the instruction operation to an architectural state of the processing device.

6. The method of claim 1, further comprising:
initiating an exception to microcode in response to determining the operand data is invalid.

7. The method of claim 6, wherein initiating an exception comprises initiating a micro fault.

8. The method of claim 1, wherein the instruction operation comprises a first instruction operation, the method further comprising:
executing, at the processing device, a second instruction operation using the operand data subsequent to executing the first instruction operation and prior to determining the validity of the operand data, wherein the second instruction operation is dependent on the first instruction operation.

9. The method of claim 8, further comprising:
retiring, at the processing device, the second instruction operation in response to determining the operand data is valid.

10. A method comprising:
receiving, at a first time, a first instruction operation at a processing device;
accessing, at a second time subsequent to the first time, operand data associated with the first instruction operation from a data cache;
providing, at a third time subsequent to the second time, the first instruction operation and the operand data for execution at the processing device;
determining, at a fourth time subsequent to the third time, the operand data is valid;
receiving, at a fifth time subsequent to the third time, execution results for the first instruction operation; and
retiring, at a sixth time subsequent to the fourth time and the fifth time, the first instruction operation at the processing device.

11. The method of claim 10, further comprising:
providing, at a seventh time subsequent to the third time, a second instruction operation for execution at the processing device, the second instruction operation being dependent on the first instruction operation;
receiving, at an eighth time subsequent to the seventh time, execution results for the second instruction operation; and
retiring, at a ninth time subsequent to the fourth time and the eighth time, the second instruction operation at the processing device.

12. The method of claim 10, wherein determining the operand data is valid comprises:
accessing error correcting code (ECC) data associated with the operand data from the data cache; and
determining the operand data is valid using the ECC data.

13. A processing device comprising:
a data cache; and
an instruction pipeline comprising:
an execution stage configured to execute an instruction operation using operand data access from the data cache prior to determining the validity of the operand data; and
a retire stage configured to retire the instruction operation in response to determining the operand data is valid.

14. The processing device of claim 13, further comprising:
an error detection module configured to determine the validity of the operand data in parallel with execution of the instruction operation by the execution stage.

15. The processing device of claim 14, wherein the error detection module is configured to:
access error correcting code (ECC) data associated with the operand data from the data cache; and
determine the validity of the operand data using the operand data and the ECC data.

16. The processing device of claim 14, further comprising:
a reorder buffer comprising a plurality of entries, each entry corresponding to an associated instruction operation and comprising a predetermined field; and
a process control unit configured to direct the retire stage to retire the instruction operation in response to determining the field of an entry of the reorder buffer associated with the instruction operation has been set to the predetermined state; and
wherein the error detection module is configured to set the field of the entry associated with the instruction operation to the predetermined state in response to determining the operand data is valid.

17. The processing device of claim 16, wherein the processing unit is configured to initiate an exception in response to determining that the operand data is invalid.

18. The processing device of claim 13, wherein:
the retire stage is configured to retire the instruction operation by committing results of the execution of the instruction operation to an architectural state of the processing device.

19. The processing device of claim 13, wherein the retire stage is configured to initiate an exception to in response to determining the operand data is invalid.

20. The processing device of claim 19, wherein the retire stage is configured to initiate an exception by initiating a microfault.
